(19) United States
(12) Patent Application Publication
(10) Pub. No.: US 2013/0207891 A1
(43) Pub. Date: Aug. 15, 2013

(54) PROJECTION SYSTEM

(71) Applicants: Wen-Wei Tsai, Hsin-Chu (TW); Kun-You Wu, Hsin-Chu (TW); Chi-Yu Lee, Hsin-Chu (TW); Ming-Wen Chen, Hsin-Chu (TW)

(72) Inventors: Wen-Wei Tsai, Hsin-Chu (TW); Kun-You Wu, Hsin-Chu (TW); Chi-Yu Lee, Hsin-Chu (TW); Ming-Wen Chen, Hsin-Chu (TW)

(73) Assignee: CORETRONIC CORPORATION, Hsin-Chu (TW)

(21) Appl. No.: 13/586,855

(22) Filed: Aug. 15, 2012

(30) Foreign Application Priority Data
Feb. 10, 2012 (CN) 201210029800.7

(51) Int. Cl. G06F 3/033

(52) U.S. Cl. 345/157

(57) ABSTRACT

A projection system includes a pointing sensing apparatus and a projection apparatus. The pointing sensing apparatus senses at least one of a plurality of instruction signals, and outputs a sensing signal accordingly. The projection apparatus displays a pointing pattern according to the sensing signal. The projection apparatus includes a control module, a first storage module and a second storage module coupled to the control module. The control module receives a plurality of image signals of different formats and generates a plurality of shrink-image data according to the image signals, respectively. The first storage module stores one of the image signals. The second storage module stores the shrink-image data. The projection apparatus displays a normal display image according to contents stored in the first storage module or displays a shrink array image according to contents stored in the second storage module in response to a selecting signal.

### CROSS-REFERENCE TO RELATED APPLICATION

This application claims the priority benefit of China application serial no. 201210029800.7, filed on Feb. 10, 2012. The entirety of the above-mentioned patent application is hereby incorporated by reference herein and made a part of this specification.

### BACKGROUND OF THE INVENTION

1. Field of the Invention

The invention relates to a projection system, and more particularly, to a projection system that displays a shrink array image according to a plurality of image signals.

2. Description of Related Art

Projection apparatuses usually support a plurality of video sources during actual use. When one of the video sources provides an image signal, the projection apparatus is sequentially switched the video sources controlled by a remote control apparatus, and whether a selected video source provides an image signal and whether the selected video source is a desired one are determined according to an image projected by the projection apparatus. Because there is a response time between the switching of the video sources and the image projecting of the projection apparatus, it may take much time to sequentially switch between the video sources to switch to the video source desired by the user. In addition, this lowers the convenience in operating the projection apparatus by the user.

Taiwan Patent No. 1272528 discloses a multiple display system that includes a display module, a storage module and a control module. A first operating area of the storage module stores sub-images of the display module and a second operating area of the storage module stores a parent-image of the display module. U.S. Pat. No. 7,551,179 discloses an image display apparatus in which a projector includes an image signal processing unit, a frame memory and an On Screen Display (OSD) memory. The frame memory stores image data. The OSD memory stores OSD image data for displaying various manipulation screens or a selection cursor. Taiwan Patent No. 307441 discloses that a display image includes a parent image and four sub-images arranged in an array. U.S. Patent Application Publication No. 20060261247 discloses an image identification system. In such a system, when an orientation device is aimed at a target point, an image sensor of the orientation device picks up an image of an orienting mark to obtain coordinates of the target point. However, the conventional techniques mentioned above all fail to provide a convenient and rapid user interface.

### SUMMARY OF THE INVENTION

Accordingly, the invention is directed to a projection system providing a humanistic interface.

Additional objectives and advantages of the invention will be set forth in the description of the techniques disclosed in the invention.

To achieve one of, a part of or all aforementioned and other objectives, an embodiment of the invention provides a projection system including a pointing sensing apparatus and a projection apparatus. The pointing sensing apparatus is used to sense at least one of a plurality of instruction signals and output a sensing signal according to the at least one of the instruction signals. The projection apparatus transmits the instruction signals and displays a pointing pattern according to the sensing signal. The projection apparatus includes a control module, a first storage module, and a second storage module. The control module receives a plurality of image signals of different formats and generates a plurality of shrink-image data according to the image signals, respectively. The first storage module is coupled to the control module, and the first storage module is used for storing one of the image signals. The second storage module is coupled to the control module, and the second storage module is used for storing the shrink-image data. The projection apparatus selectively displays a normal display image according to the contents stored in the first storage module in response to a selecting signal or displays a shrink array image according to the contents stored in the second storage module in response to the selecting signal.

In view of the foregoing, in the above embodiment of the invention, when the projection system displays the shrink array image according to the selecting signal, the projection apparatus generates the shrink-image data according to the received image signals and stores these shrink-image data into the second storage module. The projection apparatus displays the shrink array image according to the shrink-image data stored in the second storage module. As such, the projection system may provide a humanistic interface that allows the user to be informed of the image to be selected via the shrink array image. In addition, the projection apparatus displays the pointing pattern according to the sensing signal outputted from the pointing sensing apparatus. When the projection system displays a normal display image according to the selecting signal, the projection apparatus displays the normal display image according to the image signal stored in the first storage module.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a view showing a projection system according to one embodiment of the invention.

FIG. 2 is a view showing a projection system according to another embodiment of the invention.

FIG. 3 illustrates a shrink array image of FIG. 2.

### DESCRIPTION OF THE EMBODIMENTS

It is to be understood that other embodiment may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings.

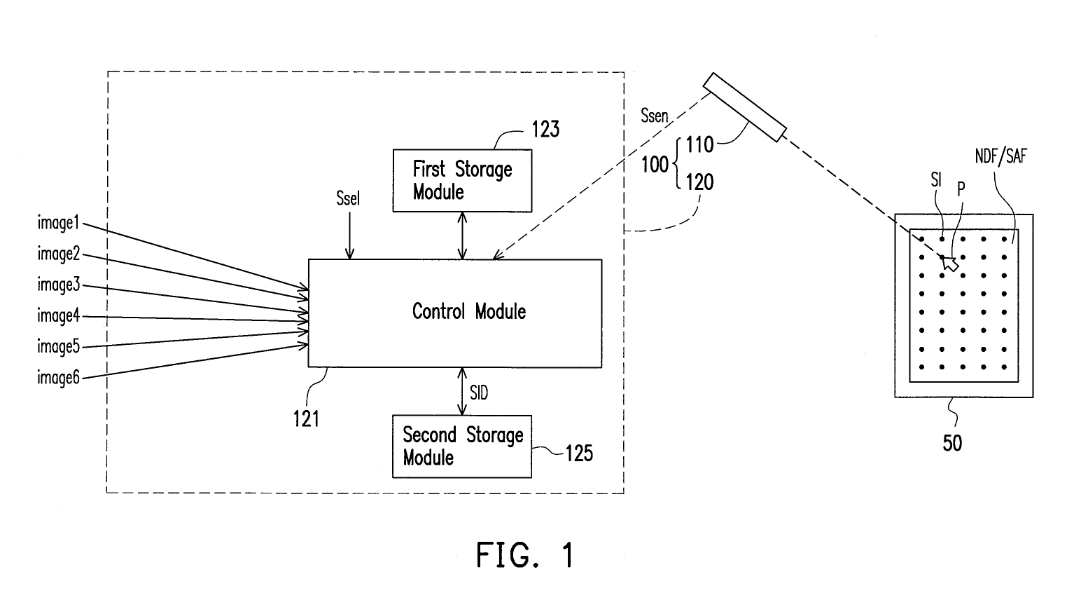

Referring to FIG. 1, the projection system 100 includes a pointing sensing apparatus 110 and a projection apparatus 120. The pointing sensing apparatus 110 is used to sense at least one of a plurality of instruction signals SI and output a sensing signal Ssen according to at least one of the instruction signals SI. The instruction signals SI are transmitted by the projection apparatus 120 to, for example, a projection screen 50. In addition, the projection apparatus 120 displays a pointing pattern P according to the sensing signal Ssen.

The projection apparatus 120 includes a control module 121, a first storage module 123, and a second storage module 125. The control module 121 receives a plurality of image signals (e.g. image1 to image6) of different formats, and the projection apparatus 120 of the embodiment receives a selecting signal Sse1 and a sensing signal Ssen through the control module 121. In addition, the control module 121 may store one of the image signals image1 to image6 into the first storage module 123. The control module 121 may also generate a plurality of shrink-image data SID according to the image signals image1 to image6, respectively, and store the plurality of shrink-image data SID into the second storage module 125.

In the embodiment, when the selecting signal Sse1 is to instruct the projection apparatus 120 to display a shrink array image (will be described later), the control module 121 may cause the projection apparatus 120 to display the shrink array image SAF according to the received selecting signal Sse1 and contents (e.g. the shrink-image data SID as described above) stored in the second storage module 125. On the other hand, when the selecting signal Sse1 is to instruct the projection apparatus 120 to display a normal display image (will be described later), the control module 121 may cause the projection apparatus 120 to display the normal display image NDF according to the received selecting signal Sse1 and one image signal (e.g. one of the image signals image1 to image6) stored in the first storage module 123.

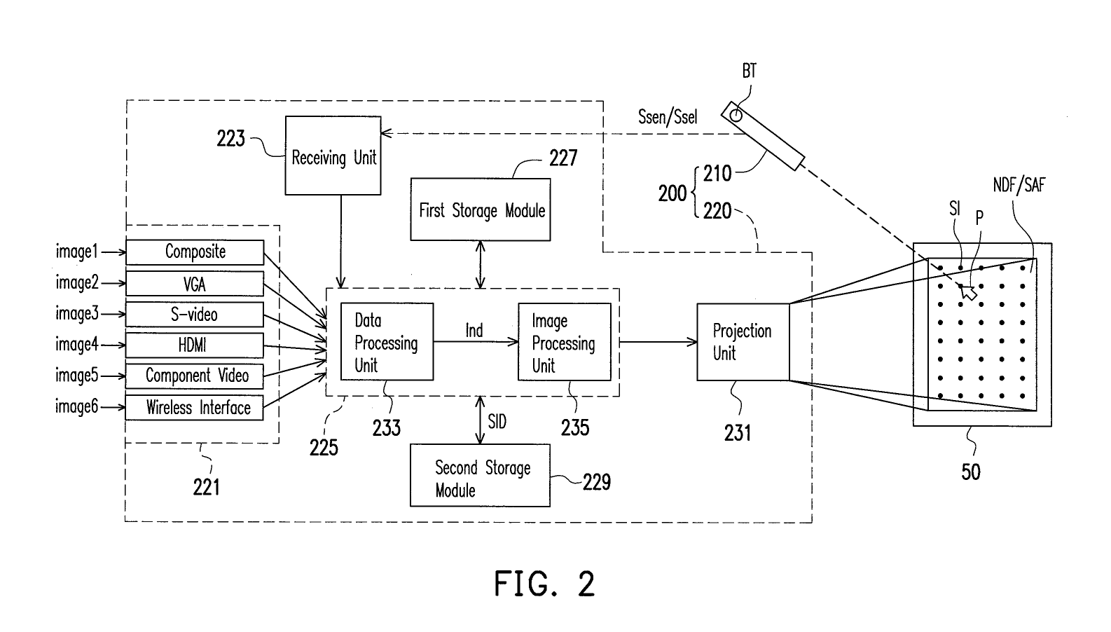

Referring to FIG. 2, the projection system 200 includes a pointing sensing apparatus 210 and a projection apparatus 220. The pointing sensing apparatus 210 is used to sense at least one of a plurality of instruction signals SI transmitted to a plurality of locations of the projection screen 50, and output a sensing signal Ssen according to at least one of the instruction signals SI. The pointing sensing apparatus 210 of the embodiment includes a button BT and transmits a corresponding selecting signal Sse1 according to a state of the button BT being pressed. The sensing signal Ssen and selecting signal Sse1 may be, but not limited to, wireless signals.

The projection apparatus 220 includes an image receiving module 221, a receiving unit 223, a control module 225, a first storage module 227, a second storage module 229, and a projection unit 231. The image receiving module 221 is used to receive image signals (e.g. image1 to image6) of different formats via different interfaces, and transmit the received image signals to the control module 225. The receiving unit 223 is used to receive the sensing signal Ssen and selecting signal Sse1 provided by the pointing sensing apparatus 210 and transmit the received signals to the control module 225.

The control module 225 may transmit a plurality of instruction signals SI to the projection screen 50. In the embodiment, the instruction signals SI are projected by the projection unit 231. And, the control module 225 may control the projection unit 231 to display a pointing pattern P on the projection screen 50 according to the sensing signal Ssen. In particular, the control module 225 may generate a pointing data Ind according to the sensing signal Ssen and control the projection unit 231 to display the pointing pattern P according to the pointing data Ind. That is, the projection apparatus 220 may display the pointing pattern P according to the pointing data Ind, such that the pointing pattern P is displayed at a location corresponding to the instruction signal SI sensed by the sensing apparatus 210. As such, the pointing pattern P is displayed on at least one of the locations of the projection screen 50 to which the instruction signals SI are projected.

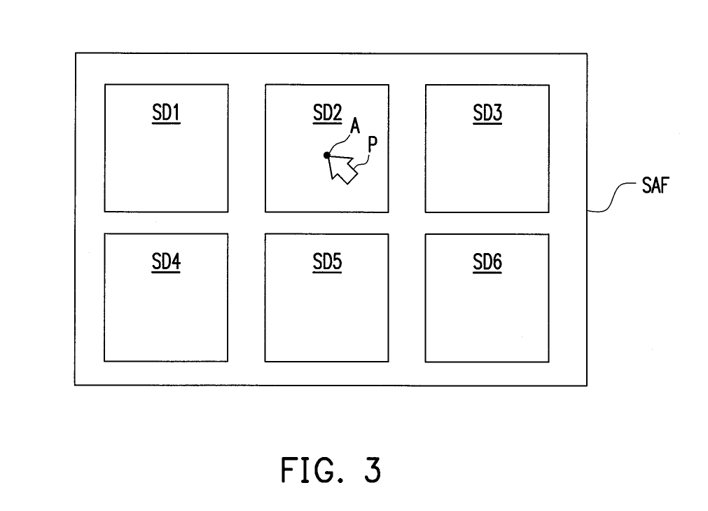

When the selecting signal Sse1 is to instruct the projection apparatus 220 to display a shrink array image SAF, the control module 225 may transmit the image signals image 1 to image6 to the first storage module 227 according to the received selecting signal Sse1. In addition, when the image signals image1 to image6 are stored in the first storage module 227, the control module 225 correspondingly generates a plurality of shrink-image data SID according to the image signals image1 to image6 stored in the first storage module 227, and stores the shrink-image data SID into the second storage unit 229. The above image signals image1 to image6 may be transmitted in a serial or parallel manner. The control module 225 may then display the shrink array image SAF according to the contents stored in the second storage module 229 (i.e. according to the shrink-image data SID), wherein the shrink array image SAF has a plurality of shrink sub-images SD1 to SD6 corresponding to the shrink-image data SID, as shown in FIG. 3. As may be seen from the above, the projection system 200 of the embodiment may provide a humanistic interface that allows a user to be informed of the image to be selected via the shrink array image SAF.

Specifically, when the selecting signal Sse1 is to instruct the projection apparatus 220 to display a normal display image NDF, the control module 225 may transmit the user-selected one of the image signals image1 to image6 to the first storage module 227 according to the received selecting signal Sse1. In addition, the control module 225 displays the normal display image NDF according to the image signal stored in the first storage module 227 (i.e. according to one of the image signals image1 to image6). The control module 225 sets an image signal (e.g. the image 1) corresponding to one (e.g. SD1) of the shrink sub-images SD1 to SD6 according to the selecting signal Sse1 and the location of the pointing pattern P so as to display the normal display image NDF. For example, the user may move the pointing sensing apparatus 210 to display the pointing pattern P at the location of a certain shrink sub-image (e.g. SD1). At this time, pressing the button BT of the pointing sensing apparatus 210 may cause the pointing sensing apparatus 210 to transmit a corresponding selecting signal Sse1, such that the control module 225 may display the normal display image NDF according to the selecting signal Sse1 and the image signal image1 corresponding to the shrink sub-image SD1.

As described above, the projection apparatus 220 may select the contents stored in the first storage module 227 to display the normal display image NDF according to the selecting signal Sse1, or select the contents stored in the second storage module 229 to display the shrink array image SAF according to the selecting signal Sse1.

In addition, when the control module 225 controls the projection unit 231 to display the normal display image NDF according to the selecting signal Sse1, the projection apparatus 220 may stop displaying the pointing pattern P to prevent the pointing pattern P from disturbing the user watching a movie. In the embodiment, the projection unit 231 is controlled by the control module 225 to stop displaying the pointing pattern P.

In the embodiment, the control module 225 includes a data processing unit 233 and an image processing unit 235. When the selecting signal Sse1 is to instruct the projection apparatus 220 to display the shrink array image SAF, the data processing unit 233 transmits the image signals image1 to image6 to the first storage module 227 and generates the pointing data Ind according to the sensing signal Ssen. On the other hand, the image processing unit 235 generates a plurality of shrink-image data SID according to the image signals image1 to image6 stored in the first storage module 227, respectively. And the image processing unit 235 controls the projection unit 231 to display the shrink array image SAF according to the contents (i.e. the shrink-image data SID) stored in the second storage module 229, and controls the projection unit 231 to display the pointing pattern P according to the pointing data Ind. The pointing pattern P is displayed on the shrink array image SAF.

In addition, when the selecting signal Sse1 is to instruct the projection apparatus 220 to display the normal display image NDF, the data processing unit 233 transmits the user-selected image signal (e.g. one of the image signals image1 to image6) to the first storage module 227, and the image processing unit 235 controls the projection unit 231 to display the normal display image NDF according to the contents stored in the first storage module 227 (i.e. the user-selected image signal).

In the embodiment, the image receiving module 221 includes Composite, Video Graphics Array (VGA), S-video, High Definition Multimedia Interface (HDMI), Component Video, and Wireless Interface. The image signals image1 to image6 are received via Composite, VGA, S-video, HDMI, Component Video, and Wireless Interface, respectively, but not limited to. In other embodiments, the image receiving module 221 may include at least two of Digital Visual Interface (DVI), Composite, VGA, S-video, HDMI, Component Video, and Wireless Interface, and the number of each interface may be determined depending upon the design of the projection apparatus 200. Therefore, embodiments of the invention have no limitations in this regard.

In addition, in one embodiment of the invention, upon the projection apparatus 220 powered on, the projection apparatus 220 is preset to display the normal display image NDF according to the contents stored in the first storage module 227. In another embodiment of the invention, upon the projection apparatus 220 powered on, the projection apparatus 220 is preset to display the shrink array image SAF according to the contents stored in the second storage module 229. The above settings are determined depending on the design of the projection apparatus and embodiments of the invention have no limitations in this regard.

Furthermore, in one embodiment of the invention, the control module 225 may arrange the second storage module 229 according to the different image formats of the image signals image1 to image6. In brief, taking the image signals image1 to image6 of six different image formats as an example, the control module 225 may arrange the second storage module 229 to have six or more than six storage areas. In addition, upon receiving one (e.g. the image signal image1) of the image signals image1 to image6, the control module 225 may store the shrink-image data SID corresponding to the image signal image1 to one storage area corresponding to the image format of the image signal image1. Addresses of the above storage areas may be continuous or discontinuous and the invention has no limitations in this regard.

Referring to FIG. 2 and FIG. 3, in the embodiment, the shrink array image SAF displays shrink sub-images SD1 to SD6 corresponding to the image signals image1 to image6 in an array (a 3×2 array is illustrated herein as an example). In addition, assuming the position of the instruction signal SI sensed by the pointing sensing apparatus 210 is the position of the shrink sub-image SD1, the pointing pattern P may be displayed at the position of the shrink sub-image SD1. Then, when the selecting signal Sse1 is transmitted to the projection apparatus 200, the control module 225 sets the corresponding image signal image2. As such, the control module 225 may transmit the image signal image2 to the first storage module 227 and control the projection unit 231 to display the normal display image NDF according to the content (i.e. the image signal image2) stored in the first storage module 227.

In summary, embodiments of the projection system have at least one of the following advantages. In embodiments of the invention, when the projection system is to display a shrink array image, the projection apparatus generates a plurality of shrink-image data according to a plurality of received image signals and displays the shrink array image according to the shrink-image data. As may be seen from the above, the projection system may provide a humanistic interface that allows the user to be informed of the image to be selected via the shrink array image. In embodiments of the invention, the projection apparatus displays a pointing pattern on the shrink array image according to a sensing signal outputted from a pointing sensing apparatus to indicate the position that the pointing sensing apparatus points to. As such, when the projection system is to display a normal display image, the projection apparatus may select a corresponding image signal according to the position that the pointing sensing apparatus points to, and displays the normal display image according to the selected image signal.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims. In addition, these claims may refer to use “first”, “second”, etc. following with noun or element. Such terms should be understood as a nomenclature and should not be construed as giving the limitation on the number of the elements modified by such nomenclature unless specific number has been given.

What is claimed is:

1. A projection system, comprising:
a pointing sensing apparatus for sensing at least one of a plurality of instruction signals, and outputting a sensing signal according to the at least one of the instruction signals; and
a projection apparatus transmitting the instruction signals, and displaying a pointing pattern according to the sensing signal, the projection apparatus comprising:
a control module receiving a plurality of image signals of different formats, and generating a plurality of shrink-image data according to the image signals, respectively;
a first storage module coupled to the control module, the first storage module is used for storing one of the image signals; and
a second storage module coupled to the control module, the second storage module is used for storing the shrink-image data,
wherein the projection apparatus selectively displays a normal display image according to contents stored in the first storage module in response to a selecting signal or displays a shrink array image according to contents stored in the second storage module in response to the selecting signal.

2. The projection system according to claim 1, wherein the instruction signals are transmitted to a plurality of locations of a projection screen, and the pointing pattern is displayed on at least one of the locations corresponding to the instruction signal sensed by the pointing sensing apparatus.

3. The projection system according to claim 2, wherein the shrink array image has a plurality of shrink sub-images corresponding to the shrink-image data, the pointing sensing apparatus transmits the selecting signal to the projection apparatus, and the projection apparatus sets the image signal corresponding to one of the shrink sub-images according to the selecting signal and the location of the pointing pattern to display the normal display image.

4. The projection system according to claim 1, wherein the pointing sensing apparatus includes a button, and the pointing sensing apparatus correspondingly transmits the selecting signal according to a state of the button being pressed.

5. The projection system according to claim 1, wherein the control module generates a pointing data according to the sensing signal, and the projection apparatus displays the pointing pattern according to the pointing data.

6. The projection system according to claim 5, wherein the control module comprises:
a data processing unit for generating the pointing data according to the sensing signal; and
an image processing unit for generating the shrink-image data according to the image signals, respectively.

7. The projection system according to claim 1, wherein the projection apparatus further comprises:
an image receiving module for receiving the image signals, and transmitting the image signals to the control module.

8. The projection system according to claim 7, wherein the image receiving module comprises at least two of Digital Video Interface, Composite, High Definition Multimedia Interface, S-video, Component Video, Video Graphics array, and Wireless Interface.

9. The projection system according to claim 1, wherein the projection apparatus further comprises:
a receiving unit for receiving the sensing signal, and transmitting the sensing signal to the control module.

10. The projection system according to claim 1, wherein the projection apparatus stops displaying the pointing pattern while displaying the normal display image.
